(19) United States
(12) Patent Application Publication
(10) Pub. No.: US 2025/0106666 A1
(43) Pub. Date: Mar. 27, 2025

(54) DATA COLLECTION FOR AI/ML MODEL

(71) Applicant: Nokia Technologies Oy, Espoo (FI)

(72) Inventors: Ethiraj ALWAR, Bangalore (IN); Sankaran BALASUBRAMANIAM, Bangalore (IN); Sakira HASSAN, Espoo (FI)

(21) Appl. No.: 18/806,256

(22) Filed: Aug. 15, 2024

(30) Foreign Application Priority Data
Sep. 27, 2023 (IN) 202311064955

(51) Int. Cl. H04W 24/10

(52) U.S. Cl. CPC H04W 24/10

(57) ABSTRACT

Approaches for implementing data collection for a task involving an Artificial Intelligence/Machine Learning (AI/ML) model present with a User Equipment (UE) are described. In one example, a data collection request may be received from the UE. The received data collection request may include an identifier of the task involving the AI/ML model, provided in the UE, for which data is to be collected. Thereafter, a measurement configuration may be determined corresponding to the identifier of the task. Subsequently, a response message may be transmitted to the UE. The response message may include a measurement identifier corresponding to the measurement configuration.

### RELATED APPLICATION

This application claims priority from Indian Provisional Patent Application No. 202311064955 filed on Sep. 27, 2023, which is hereby incorporated in its entirety.

### TECHNICAL FIELD

Approaches and examples for implementing data collection for a task involving an Artificial Intelligence/Machine Learning (AI/ML) model are described.

### BACKGROUND

In a communication network, such as a 5th generation (5G) network, a variety of approaches may be used to improve the efficiency of various network and/or communication functions that may be implemented by an entity within the telecommunication network. The efficient and performant functioning of the communication systems has been possible through control functions implemented by way of logical instructions. Recently, such controls have been implemented through the use of models enabled through artificial intelligence. Such models comprise a variety of data driven functions that uses machine learning techniques to generate a set of outputs comprising of predicted information and/or decision parameters.

The Artificial Intelligence/Machine Learning model (referred to as the AI/ML model) may be trained through either an online or offline process. The training involves subjecting the AI/ML model to a variety of training datasets which enable the AI/ML model to learn features and patterns. In the context of a communication network, the trained AI/ML model thereafter may be used to enable different network operations to implement the functioning of the communication network. The training dataset may be obtained by collecting data of the different network operations when a user equipment, i.e., the UE, engages with any one or more network devices within the network.

### SUMMARY

Aspects of the present subject matter relate to approaches for implementing data collection for a task involving an Artificial Intelligence/Machine Learning (AI/ML) model.

In an example, a network apparatus for implementing data collection for a task involving an Artificial Intelligence/Machine Learning (AI/ML) model present with a User Equipment (UE) is described. The network apparatus may include at least one processor, and at least one memory. The at least one memory may store instructions that may be executed by the at least one processor. The instructions, when executed by the at least one processor, may cause the network apparatus to perform one or more functions. For example, upon execution of the instructions, the network apparatus may receive a data collection request from a User Equipment (UE). The received data collection request may include an identifier of a task involving an Artificial Intelligence/Machine Learning (AI/ML) model for which data is to be collected. The AI/ML model may be provided in the UE. The network apparatus may then determine a measurement configuration corresponding to the identifier of the task. Thereafter, a response message may be transmitted to the UE. The response message may include a measurement identifier corresponding to the measurement configuration.

In one example, based on the measurement configuration corresponding to the measurement identifier, the network apparatus may further cause reconfiguration of a radio communication link associated with the UE.

In another example, the data collection request may include at least one of a first set of attributes and a type of request. The first set of attributes may be used for the data collection corresponding to the data collection request. Further, the type of request may indicate one of initiation or termination of the data collection.

In yet another example, the first set of attributes may include at least one of a time instance of initiating data collection, a time instance of terminating data collection, periodicity of data collection, sensitivity of data requirement, or a characteristic of a geographical area for performing the data collection.

In yet another example, the response message may further include a list of a second set of attributes determined using the first set of attributes.

In yet another example, the network apparatus may further retrieve a mapping between a plurality of tasks and a plurality of measurement configurations. Based on the mapping and the identifier of the task obtained from the data collection request, the network apparatus may determine the measurement configuration.

In yet another example, the network apparatus may further determine a first configuration corresponding to an earlier configured radio communication link associated with the UE. Thereafter, the network apparatus may assess the first configuration based on the determined measurement configuration to determine whether the first configuration can be used for configuring the radio communication link associated with the UE for the data collection. On ascertaining that the first configuration can be used, the network apparatus may use the first configuration as the measurement configuration for configuring the radio communication link associated with the UE for the data collection.

In yet another example, based on the assessing of the first configuration, the network apparatus may further ascertain that the first configuration cannot be used for configuring the radio communication link associated with the UE for the data collection. The network apparatus may then determine a second configuration. Thereafter, the network apparatus may use the second configuration as the measurement configuration for configuring the radio communication link associated with the UE for the data collection.

In yet another example, the network apparatus may process the data collection request received from the UE. The radio communication link associated with the UE may be configured previously. Thereafter, based on a previously configured measurement of the UE, the network apparatus may determine the measurement configuration. Subsequently, the network apparatus may transmit the response message to the UE. The response message may include the measurement identifier corresponding to the measurement configuration to configure the partially previously configured radio communication link associated with the UE.

In yet another example, the network apparatus may process a data collection termination request received from the UE. The termination request may include logs pertaining to the data collection performed pursuant to the data collection request. On determining that the termination request conforms with a predefined condition, the network apparatus may then transmit control instructions to the UE. The control instructions may be executable by the UE to reconfigure a radio communication link associated with the UE to terminate the data collection by the UE.

In another example, a User Equipment (UE) for implementing data collection for a task involving an Artificial Intelligence/Machine Learning (AI/ML) model present with the UE is described. The network apparatus may include at least one processor, and at least one memory. The at least one memory may store instructions that may be executed by the at least one processor. The instructions, when executed by the at least one processor, may cause the User Equipment (UE) to perform one or more functions. For example, upon execution of the instructions, the UE may transmit a data collection request. The data collection request may include an identifier of a task involving an Artificial Intelligence/Machine Learning (AI/ML) model for which data is to be collected. The AI/ML model may be provided in the UE. The UE may then receive a response message. The response message may include a measurement identifier of a measurement configuration corresponding to the identifier of the task. Thereafter, based on the measurement configuration, the UE may collect data for the task involving the AIM; model.

In one example, based on the response message, the task may include at least one of training of the AI/ML model, retraining of the AI/ML model, monitoring of the AI/ML model, monitoring of functions performed by the UE, or inferencing using the AI/ML model.

In another example, the UE may further include at least one of a first set of attributes and a type of request. The first set of attributes may be used for the data collection corresponding to the data collection request. The type of request may indicate one of initiation or termination of the data collection.

In yet another example, the UE may further transmit a termination request. The termination request may include logs pertaining to the data collection performed pursuant to receiving the response message. Thereafter, the UE may execute control instructions received from the network apparatus in response to the termination request. The control instructions, when executed, may further reconfigure the radio communication link to terminate the data collection by the UE.

In yet another example, a method for implementing data collection for a task involving an Artificial Intelligence/Machine Learning (AI/ML) model present with a User Equipment (UE) is described. A network apparatus may receive a data collection request from a User Equipment (UE). The received data collection request may include an identifier of a task involving an Artificial Intelligence/Machine Learning (AI/ML) model for which data is to be collected. Further, the AI/ML model may be provided in the UE. Thereafter, the network apparatus may determine a measurement configuration corresponding to the identifier of the task. Thereafter, the network apparatus may transmit a response message to the UE. The response message may include a measurement identifier corresponding to the measurement configuration.

In yet another example, a method for implementing data collection for a task involving an Artificial Intelligence/Machine Learning (AI/ML) model present with a User Equipment (UE) is described. A User Equipment (UE) may transmit a data collection request. The data collection request may include an identifier of a task involving an Artificial Intelligence/Machine Learning (AI/ML) model for which data is to be collected. Further, the AI/ML model may be provided in the UE. Thereafter, the UE may receive a response message. The response message may include an identifier of a measurement configuration corresponding to the identifier of the task. Thereafter, the UE may collect data based on the measurement configuration for the task involving AI/ML model.

In one example, the task may include at least one of training of the AI/ML model, retraining of the AI/ML model, monitoring of the AI/ML model, monitoring of functions performed by the UE, or inferencing using the AI/ML model.

In another example, the data collection request may include one of a first set of attributes and a type of request. The first set of attributes may be used for the data collection corresponding to the data collection request. Further, the type of request may indicate one of initiation or termination of the data collection.

In yet another example, the first set of attributes may include at least one of a time instance of initiating data collection, a time instance of terminating data collection, periodicity of data collection, sensitivity of data requirement, or a characteristic of geographical area for performing the data collection.

In yet another example, a non-transitory computer readable medium is described. The non-transitory computer readable medium may include computer-readable instructions. The instructions, when executed by a processor, may cause a network apparatus to implement data collection for a task involving an Artificial Intelligence/Machine Learning (AI/ML) model present with a User Equipment (UE). The instructions may cause the network apparatus to receive a data collection request from a User Equipment (UE). The received data collection request may include an identifier of a task involving an Artificial Intelligence/Machine Learning (AI/ML) model for which data is to be collected. The AI/ML model may be provided in the UE. Thereafter, the instructions may further cause to determine a measurement configuration corresponding to the identifier of the task. The instructions may furthermore cause to transmit a response message to the UE. The response message may include a measurement identifier corresponding to the measurement configuration.

In one example, based on the measurement configuration corresponding to the measurement identifier, the instructions may further cause a reconfiguration of a radio communication link associated with the UE.

In yet another example, a non-transitory computer readable medium is described. The non-transitory computer readable medium may include computer-readable instructions. The instructions, when executed by a processor, may cause a User Equipment (UE) to implement data collection for a task involving an Artificial Intelligence/Machine Learning (AI/ML) model present with the UE. The instructions may cause the UE to transmit a data collection request. The data collection request may include an identifier of a task involving an Artificial Intelligence/Machine Learning (AI/ML) model for which data is to be collected. The AI/ML model may be provided in the UE. Thereafter, the instructions may further cause the UE to receive a response message. The response message may include a measurement identifier of a measurement configuration corresponding to the identifier of the task. The instructions may furthermore cause the UE to collect data, based on the measurement configuration, for the task involving the AI/ML model.

### BRIEF DESCRIPTION OF THE DRAWINGS

The following detailed description references the drawings, wherein:

FIG. 1 illustrates a network apparatus for implementing data collection for a task involving an Artificial Intelligence/Machine Learning (AI/ML) model present with a User Equipment (UE), as per an implementation of the present subject matter;

FIG. 2 illustrates a User Equipment (UE) for implementing data collection for a task involving an Artificial Intelligence/Machine Learning (AI/ML) model present within the UE, as per an implementation of the present subject matter;

FIG. 3 illustrates a network environment comprising a network apparatus for implementing data collection for a task involving an Artificial Intelligence/Machine Learning (AI/ML) model present with a User Equipment (UE), as per an implementation of the present subject matter;

FIG. 4 is a block diagram of a network apparatus for implementing data collection for a task involving an Artificial Intelligence/Machine Learning (AI/ML) model present with a User Equipment (UE), as per an implementation of the present subject matter;

FIG. 5 is an example call-flow diagram depicting various functionalities between a User Equipment (UE) and a network apparatus for implementing data collection for a task involving an Artificial Intelligence/Machine Learning (AI/ML) model present with the UE, as per an implementation of the present subject matter;

FIG. 6 is an example call flow diagram depicting various functionalities between a User Equipment (UE) and a network apparatus for implementing data collection for a task involving an Artificial Intelligence/Machine Learning (AI/ML) model present with the UE, as per another implementation of the present subject matter;

FIG. 7 is an example call flow diagram depicting various functionalities between a User Equipment (UE) and a network apparatus for implementing data collection for a task involving an Artificial Intelligence/Machine Learning (AI/ML) model present with the UE, as per yet another implementation of the present subject matter;

FIG. 8 is an example call-flow diagram depicting various functionalities between a User Equipment (UE) and a network apparatus for terminating the data collection, as per an implementation of the present subject matter;

FIG. 9 is a flowchart depicting an example method to be implemented in a network apparatus for implementing data collection for a task involving an Artificial Intelligence/Machine Learning (AI/ML) model present with the UE, as per an implementation of the present subject matter;

FIG. 10 is a flowchart depicting an example method to be implemented in a User Equipment (UE) for implementing data collection for a task involving an Artificial Intelligence/Machine Learning (AI/ML) model present with the UE, as per an implementation of the present subject matter;

FIG. 11 is a flowchart depicting an example method for implementing data collection for a task involving an Artificial Intelligence/Machine Learning (AI/ML) model present with a User Equipment (UE), as per an implementation of the present subject matter;

FIG. 12 illustrates a non-transitory computer-readable medium for implementing data collection for a task involving an Artificial Intelligence/Machine Learning (AI/ML) model present with a User Equipment (UE), as per an implementation of the present subject matter; and

FIG. 13 illustrates a non-transitory computer-readable medium for implementing data collection for a task involving an Artificial Intelligence/Machine Leaning (AI/ML) model present with a User Equipment (UE), as per another implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A communication network may typically involve multiple user devices that may be interacting with one or more network devices. Each of the devices, through their respective functionalities, may perform one or more network operations. Within the network, different devices may be in communication with each other, over the communication network, and may facilitate the exchange of data. Further, the manner in which the communication between different devices may be implemented, may be based on the corresponding network protocols. In the context of a 5th generation (5G) network, all the communication between different network or user devices may be based on network protocols as prescribed in the 5G protocol stack.

Artificial Intelligence/Machine Learning (AI/ML) models and techniques have been used for furthering the operational efficiency of the communication network. For example, AI/ML based techniques have been utilized for network energy savings, load balancing, and mobility optimization. It may be noted that the aforesaid examples are only indicative and do not represent the entirety of the network functions or operations that may be implemented using AI/ML models and/or techniques. The AI/ML models for implementing such techniques may be implemented either within the radio access network or may be implemented within the UE.

As discussed above, the AI/ML model may be trained based on collected data. The data collection, in certain instances, may be performed by the UE itself. In such cases, the data collection is controlled or managed by the access network. As a result, the access network configures the UE for the data collection of measurements that may be required to be collected. Based on the configurations provided by the access network, the UE may collect the measurements which may be subsequently transmitted to the access network. Although such approaches may be followed when the AI/ML model is implemented in the access network, such approaches may not be sufficient in cases where the AI/ML model is implemented within the UE itself.

As may be understood, the data collected (also referred to as the measurements) by the UE based on RAN configuration may not be sufficient for training, or for configuring various other tasks involving the AI/ML model within the UE. For example, the time of configuration for data collection may be different from what the UE requires. In some other instance, attributes like periodicity of measurement collection may also differ in the RAN-based configuration. Such aspects may result in challenges particularly in the context of multiple vendors where UEs from different vendors (each having their own AI/ML model) may have to communicate and operation with the access network from another vendor.

Furthermore, in other instances, the data required by the AI/ML model of the UEs along with its attributes may be known only to the UE and not the access network, thereby always posing a risk that the data collected by the UE (based on the configurations provided by the access network) would not be sufficient for the tasks (that may involve the AI/ML model). Still further, certain types of measurements (like inter-frequency and inter-RAT measurements) require measurement gaps to be configured which if not performed cannot enable the UE to collect data. These challenges may further aggravate the problem of inaccuracy in the configuration, thereby posing challenges in data collection.

Approaches for implementing data collection for a task involving an Artificial Intelligence/Machine Learning (AI/ML) model present with a User Equipment (UE) are described. In an example, the data collection or measurements may be initiated by the UE through a data collection request. The data collection request may include an identifier of a task which may involve and may be performed using an AI/ML model that is implemented within the UE itself. The tasks involving the AI/ML model may include a variety of tasks, examples of which include, but are not limited to, training of the AI/ML model, retraining of the AI/ML model monitoring of the AI/ML model, monitoring of functions performed by the UE, or inferencing using the AI/ML model. It may be noted that the following examples are only indicative and are not exhaustive. Other example tasks for which the data collection may be performed are also possible without deviating from the scope of the present subject matter.

Returning to the present example, the data collection request may include the identifier of the task, for which the data collection is to be performed. The data collection request may thereafter be shared with a network apparatus within the access network. The network apparatus on receiving the data collection request may process the same and accordingly determine one or more measurement configurations. In an example, the one or more measurement configurations may be determined based on a predefined mapping that may be available with the network apparatus. The network apparatus, to this end, may compare the identifier of the task as provided in the data collection request with a plurality of tasks and accordingly may determine configuration for the required measurement(s) (i.e. a measurement configuration). The measurement configuration may be considered as defining a manner in which the UE may perform the measurements, or any communication or data exchange, based on which the data collection process is to be performed by the UE.

Once the one or more measurement configurations are determined, the network apparatus may generate a response message based on the identified one or more measurement configurations. In an example, the response message may include an identifier of the identified measurement configuration(s). The network apparatus may thereafter transmit the response message to the UE within the access network. The response message may be used thereafter for configuring the radio communication link associated with the UE (i.e., for reconfiguring a current measurement configuration for the UE or for configuring a new measurement configuration for the UE). Once the radio communication link is configured, the UE may commence the data collection based on the configuration by the network apparatus (as per the measurement configurations). The radio communication link may refer to an RRC connection between the UE and the network apparatus, and the configuration or reconfiguration of the radio communication link may modify the RRC connection including setup/modification/release of measurement configurations.

In an example, different configurations may be used as measurement configuration for configuring the radio communication link associated with the UE for the data collection. For instance, the network apparatus may determine a first configuration based on which the configuration of the radio communication link may be performed. The first configuration may be similar to configuration settings of an earlier configured radio communication link that may have been previously established for the UE. In another example, the network apparatus may determine a second configuration based on which the radio communication link may be configured afresh.

As would be appreciated, the current approaches enable the UE to specify the tasks for which data collection is required. Based on the same, the network apparatus, depending on the request received from the UE, configures the radio communication link for data collection. As a result, the UE may be able to efficiently collect data for the intended task. Since the configuration of the radio communication link is based on the requirements communicated by the UE, the data collection enabled for the UE is thus aligned with the requirement of the UE.

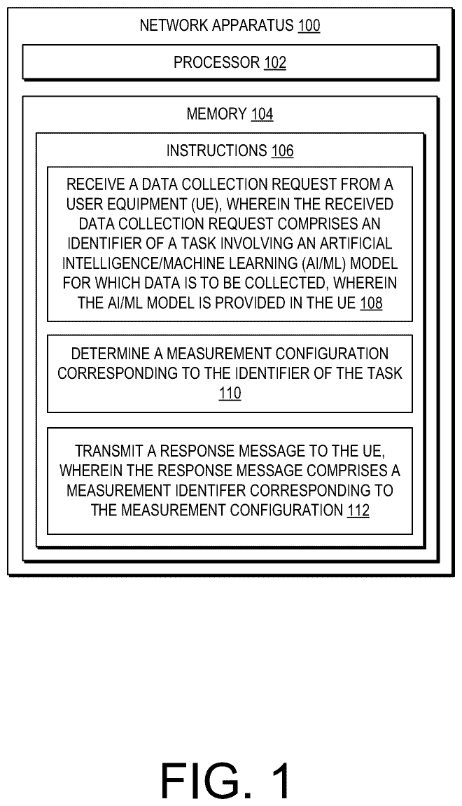

The manner in which the above-mentioned examples are implemented has been explained in detail with respect to FIGS. 1-13. While aspects of the present subject matter may be implemented in a variety of different communication systems, transmission environments, and/or configurations, the implementations are described in the context of the following system(s) as examples.

The terms during, while, and when as used herein are not exact terms that mean an action takes place instantly upon an initiating action but that there may be certain delay, such as a propagation delay, between the initial action and the reaction that is initiated by the initial action. Additionally, the words “connected” and “coupled” are used throughout for clarity of the description and can include either a direct connection or an indirect connection. Various examples of the present subject matter have been described below by referring to several examples.

FIG. 1 illustrates a network apparatus 100, which enables implementation of data collection for a task involving an Artificial Intelligence/Machine Learning (AI/ML) model present with a User Equipment (UE), as per an implementation of the present subject matter. In one example, the network apparatus 100 may be implemented within an access network. In the context of the access network being a 5th Generation (5G) network, the network apparatus 100 may be implemented at the RRC (Radio Resource Control) layer of the 5G protocol stack. In another example, the network apparatus 100 may be one of a base station device and a gNodeB (gNB). It yet another example, the network apparatus 100 may also be implemented as any hardware-based, software-based, or network-based entity. It may be further noted that, such network apparatus 100 may be understood based on the type of access network in which the network apparatus 100 may be implemented.

As depicted in FIG. 1, the network apparatus 100 includes a processor 102 and a memory 104 which is coupled to, and accessible by, the processor 102. Although not depicted, the network apparatus 100 may include other components, such as interfaces to communicate over the access network with external storage or computing devices, display, input/output interfaces, operating systems, applications, data, and other software or hardware components (all of which have not been depicted for sake of conciseness). In an example, the memory 104 may further include instruction(s) 106.

The processor 102 may be implemented as a dedicated processor, a shared processor, or a plurality of individual processors, some of which may be shared. The memory 104 may be communicatively connected to the processor 102. Among other capabilities, the processor 102 may fetch and execute computer-readable instructions, including instruction(s) 106, stored in the memory 104. The memory 104 may be implemented as, for example, volatile memory such as RAM (Random Access Memory), or non-volatile memory such as EPROM (Erasable Programmable Read Only Memory), flash memory, and the like. The instruction(s) 106 may be executed to enable implementation of data collection for a task involving an Artificial Intelligence/Machine Learning (AI/ML) model present with a User Equipment (UE).

Although not depicted, the network apparatus 100 may be in communication with a plurality of User Equipment or UEs through communication links (wired to wireless) implemented within the access network. In the context of the present example, each of the UEs may include a respective Artificial Intelligence/Machine Learning (AI/ML) model, which has been explained later in the foregoing description.

In operation, the processor 102 may fetch and execute instruction(s) 106 for performing one or more actions, as discussed further. For example, as a result of the execution of instructions 108, the network apparatus 100 may receive a data collection request from a User Equipment (UE). The received data collection request may include an identifier of a task involving an Artificial Intelligence/Machine Learning (AI/ML) model for which data is to be collected. As described previously, the AI/ML model may be provided in the UE. Thereafter, the instructions 110 may be executed to determine a measurement configuration corresponding to the identifier of the task.

Continuing further, instructions 112 may then be executed to transmit a response message to the UE. The response message may include a measurement identifier of the measurement configuration. Based on the measurement configuration corresponding to the measurement identifier, the instructions 106, in another example, may further cause reconfiguration of a radio communication link associated with the UE.

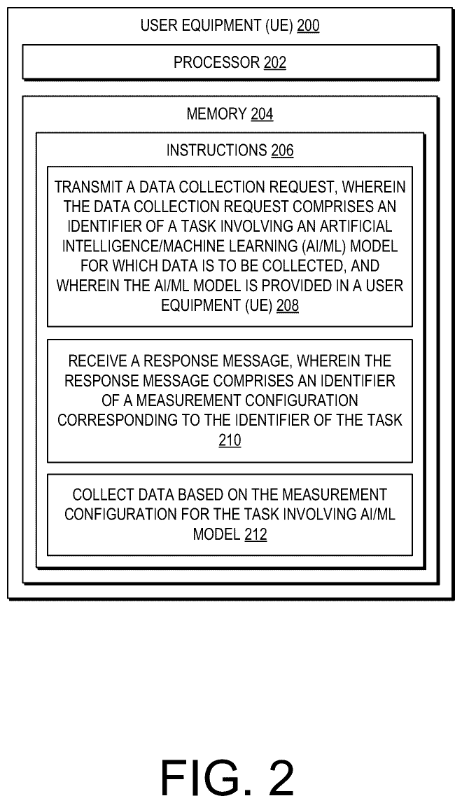

The manner in which the UE receives the response message in response to the data collection request provided by the UE, is explained in further details in conjunction with FIG. 2. FIG. 1 illustrates a User Equipment 200, which enables implementation of data collection for a task involving an Artificial Intelligence/Machine Learning (AI/ML) model present with the UE, as per an implementation of the present subject matter. Examples of UE 200 may include, but are not limited to, a mobile phone, a Personal Computer (PC), a portable computer, a laptop, a tablet, a wearable device, or any other device used by an end user. It may be noted that such examples of UE 200 are only illustrative, and any other examples would also lie within the scope of the present subject matter.

As depicted in FIG. 2, the UE 200 includes a processor 202 and a memory 204 which is coupled to, and accessible by, the processor 202. Although not depicted, the UE 200 may include other components, such as interfaces to communicate over the access network with external storage or computing devices, display, input/output interfaces, operating systems, applications, data, and other software or hardware components (all of which have not been depicted for sake of conciseness). In an example, the memory 204 may further include instruction(s) 206.

The processor 202 and the memory 204 may be implemented in a similar manner, as that of processor 102 and memory 104. Such explanations have not been provided here again for the sake of brevity. The memory 204 may be communicatively connected to the processor 202. Among other capabilities, the processor 202 may fetch and execute computer-readable instructions, including instruction(s) 206, stored in the memory 204. The instruction(s) 206 may be executed to enable implementation of data collection for a task involving an Artificial Intelligence/Machine Learning (AI/ML) model present with the UE 200.

In operation, the processor 202 may fetch and execute instruction(s) 206 for performing one or more actions, as discussed further. For example, as a result of the execution of instructions 208, the UE 200 may transmit a data collection request. The data collection request may include an identifier of a task involving an Artificial Intelligence/Machine Learning (AI/ML) model for which data is to be collected. As described previously, the AI/ML model (not shown in FIG. 2) may be provided in the UE 200. Thereafter, the instructions 210 may be executed to receive a response message. The response message may include a measurement identifier of a measurement configuration corresponding to the identifier of the task.

Continuing further, based on the measurement configuration, the instructions 212 may then be executed to collect data for the task involving the AI/ML model.

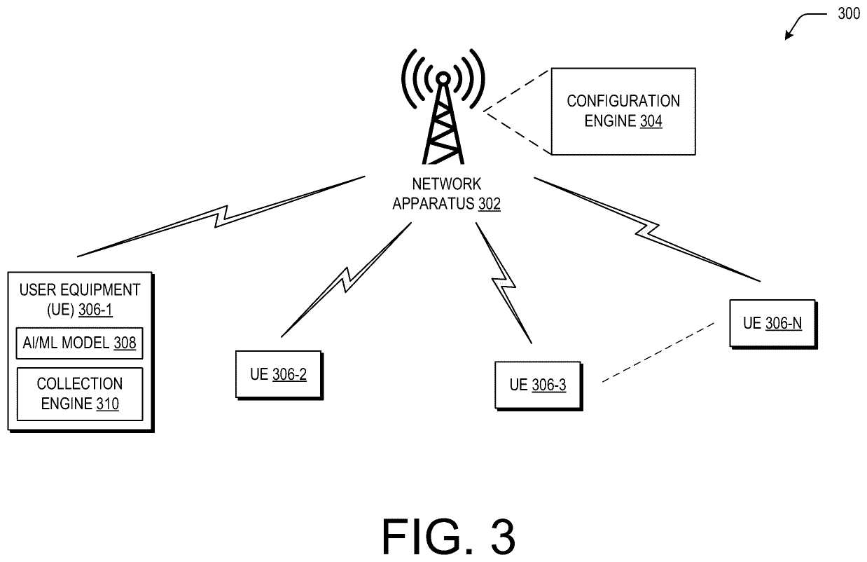

The above functionalities performed as a result of the execution of the instructions 106 and 206 may be performed by different programmable entities. The manner in which the network apparatus 100 and the User Equipment 200 enables implementation of data collection for a task involving the AI/ML model present with the UE, is explained in further detail in conjunction with FIGS. 3-13.

FIG. 3 illustrates a network environment 300 for implementation of data collection for a task involving an AI/ML model present with a UE, as per an implementation of the present subject matter. The network environment 300 (referred to as environment 300) may be a part of any access network. In another example, the network environment 300 may be a part of any other communication network as well, such as a 5th generation (5G) network. In such cases, the entities implemented within the 5G network may operate based on 5G protocol stack. It may be noted that the present approach may be implemented to any access network or any communication network. All such examples would lie within the scope of the present subject matter.

The environment 300 may include a network apparatus 302. In one example, the network apparatus 302 may be similar to the network apparatus 100, as described in conjunction with FIG. 1. In the context of the environment 300 implemented within a 5th Generation (5G) network, the network apparatus 302 may be implemented with the RRC (Radio Resource Control) layer of the 5G protocol stack. In another example, the network apparatus 302 may be one of a base station device and a gNodeB (gNB). The network apparatus 302 may include configuration engine 304. In one example, the configuration engine 304 may be implemented as a processing resource.

As further depicted in FIG. 3, the network environment 300 may include a plurality of User Equipment (UEs) 306-1, 306-2, . . . , 306-N (collectively referred to as UEs 306, and individually referred to as UE 306) which in turn may be in communication with the network apparatus 302. In one example, the UE 306 may be similar to the UE 200, as described in conjunction with FIG. 2. Each of the UE 306 may include an Artificial Intelligence/Machine Learning (AI/ML) model 308 and a collection engine 310. In one example, the collection engine 310 may be implemented as a processing resource. Although the AI/ML model 308 and the collection engine 310 have been depicted only in the UE 306-1, it may be noted that the same is done only for the sake of clarity. All other UEs may also include their respective AI/ML model and collection engine.

In an example, the network apparatus 302 may be adapted to operate for a 5G-NR (i.e., the New Radio) which in turn may interface with a core network through one or more backhaul links. In addition to other functions, the network apparatus 302 may perform a variety of functions including, but not limited to, transfer of user data, radio channel ciphering and deciphering, integrity protection, header compression, mobility control functions (e.g., handover, dual connectivity), paging, positioning, and delivery of warning messages, etc. The network apparatus 302 may communicate directly or indirectly with each other similar base station devices over backhaul links, which in turn may be wired or wireless.

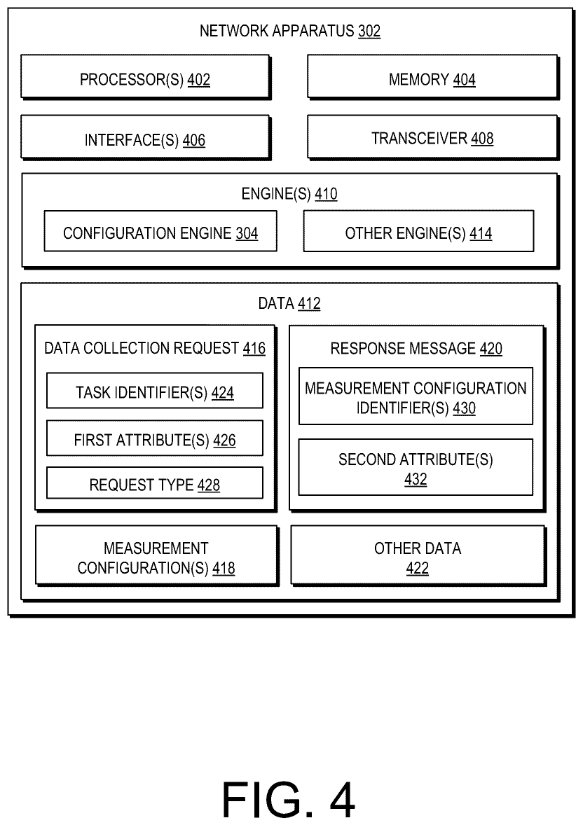

Returning to the present example, in operation, the network apparatus 302 may reconfigure radio communication link associated with the UE 306-1, thereby implementing data collection for a task involving the AI/ML model 308 present with the UE 306-1. The operation of the different elements within the environment 300 is further explained with respect to the logical components of the network apparatus 302, as depicted in FIG. 4. It may be further noted that although the foregoing description has been explained with respect to reconfiguration of the radio communication link of the UE 306-1, the same may not be construed to limit the scope of the present subject matter in any manner. The proposed approach may be implemented to all other UEs in the environment 300, and all such examples would lie within the scope of the present subject matter.

FIG. 4 illustrates a block diagram of an example network apparatus 302, to be implemented in the network environment 300, as per an example of the present subject matter. The network apparatus 302 may be similar to the network apparatus 100 as described in FIG. 1.

In the present example, the network apparatus 302 includes processor(s) 402, memory 404, interface(s) 406, and transceiver 408. The processor(s) 402 may also be implemented as signal processor(s), state machine(s), and/or any other device or component that manipulate signals based on operational instructions. The memory 404 may store one or more executable instructions, which may be fetched and executed so as to perform one or more operations for enabling data collection for a task by a UE. The memory 404 may also be used for storing data which may be generated or utilized during the operation of the network apparatus 302. The memory 404 may be non-transitory computer-readable medium including, for example, volatile memory, such as RAM, or non-volatile memory such as EPROM, flash memory, and the like.

The interface(s) 406 may include a variety of interfaces, for example, interfaces for data input and output, and for exchanging a variety of operational instructions between other devices, such as the devices within the environment 300. The interface(s) 406 may also be relied for implementing communication between the network apparatus 302 and the User Equipment (UEs) 306, as depicted in FIG. 3. The interface(s) 406 may be implemented as either hardware or software. The transceiver 408 may be used by the network apparatus 302 to transmit or receive data or signals, while communicating with other components in the environment 300.

The network apparatus 302 may further include engine(s) 410 and data 412. The engine(s) 410 may be implemented as a combination of hardware and programming (e.g., program instructions) to implement one or more functionalities of the network apparatus 302. In examples described herein, such combinations of hardware and programming may be implemented in several different ways. For example, the programming for the engine(s) 410 may be executable instructions. Such instructions may be stored on a non-transitory machine-readable storage medium which may be coupled either directly with the network apparatus 302 or indirectly (for example, through networked means). In an example, the engine(s) 410 may include a processing resource, for example, either a single processor or a combination of multiple processors, to execute such instructions. In the present examples, the non-transitory machine-readable storage medium may store instructions that, when executed by the processing resource, implement engine(s) 410. In other examples, the engine(s) 410 may be implemented as electronic circuitry.

In one example, the engine(s) 410 may include a configuration engine 304 and other engine(s) 414. The other engine(s) 414 may implement one or more additional functionalities of the network apparatus 302. The data 412 includes information that may be utilized or generated by engine(s) 410 during the course of operation of the network apparatus 302. In one example, the data 412 includes data collection request 416, measurement configuration(s) 418, response message 420, and other data 422. Further, the data collection request may include task identifier(s) 424, first attribute(s) 426, and request type 428. The response message 420 may include measurement configuration identifier(s) 430 and second attribute(s) 432.

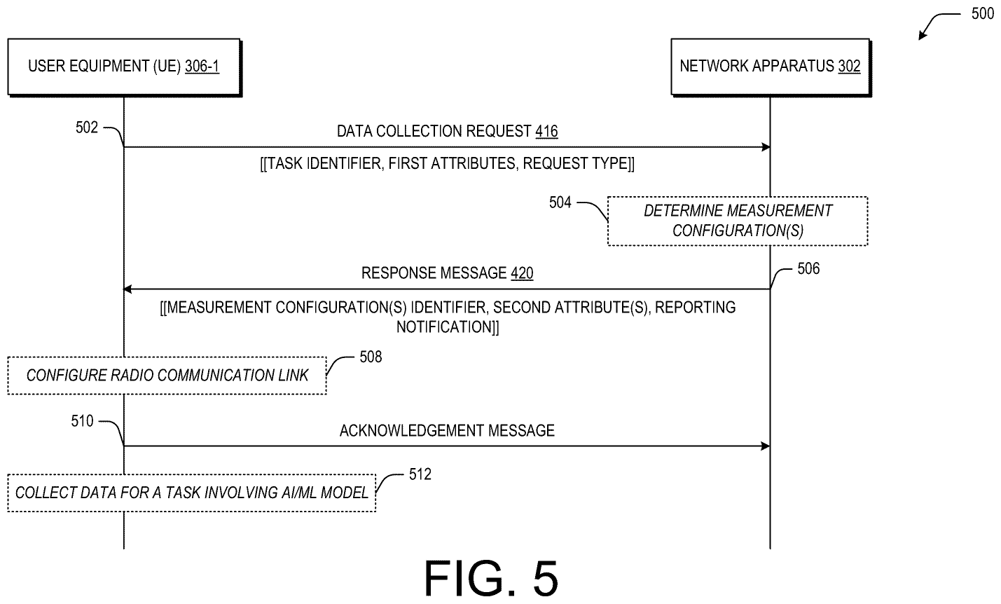

It may be noted that, along with the foregoing description of FIGS. 3-4, the manner in which the data collection for a task involving an Artificial Intelligence/Machine Learning (AI/ML) model present with the UE 306-1 is implemented, is further explained in conjunction with a call flow diagram as illustrated in FIG. 5. FIG. 5 illustrates an example call-flow diagram 500 depicting various functionalities between the UE 306-1 and the network apparatus 302 for implementing data collection for a task involving an Artificial Intelligence/Machine Learning (AI/ML) model present with the UE 306-1, as per an implementation of the present subject matter. As depicted, the call flow diagram 500 provides a series of exchanges between the UE 306-1 and the network apparatus 302, as per an example. In an example, the messaging between the UE 306-1 and the network apparatus 302 may be based on an RRC protocol-based signalling.

In operation, a plurality of User Equipment (UEs) 306 may be in communication with the network apparatus 302 in the access network. Each of the UEs 306 may include an Artificial Intelligence/Machine Learning (AI/ML) model 308. The AI/ML model 308 may be used for furthering the operational efficiency of the respective UE 306 in which the said AI/ML model 308 may be provided. As discussed previously, some of the functions which are to be enabled through the AI/ML model 308 may be specific for a given UE, say the UE 306-1, and which may be different for functions which need to be enabled through the AI/ML model 308 implemented within another UE, UE 306-2. As a result, the data to be collected by the different UEs 306 may differ as well.

The foregoing example is described from the perspective of UE 306-1. It may be noted that the approaches thus explained in conjunction with the present example, would also be applicable for other UEs 306. Such examples would also fall within the scope of the present subject matter.

Utilizing the AI/ML model 308 for implementing a variety of UE or network related functions may require that the AI/ML model 308 be trained. Once trained, the AI/ML model 308 may be implemented within the UE 306-1 for implementing such functions. During the course of its implementation, the performance of the AI/ML model 308 may be monitored and it may be determined that additional training be performed for the AI/ML model 308. To this end, the collection engine 310 of the UE 306-1 collects data which may be used for a variety of tasks involving the AI/ML model 308. It may be noted that examples of such tasks involving the AI/ML model 308 may include, but are not limited to, training of the AI/ML model 308, retraining of the AI/ML model 308, monitoring of the AI/ML model 308, monitoring of functions performed by the UE 306-1, or inferencing using the AI/ML model 308. It may be noted that the following examples are only indicative and are not exhaustive. Other example tasks may also be possible without deviating from the scope of the present subject matter. It may also be noted that the tasks involving the AI/ML model 308 may also include certain other functions to be performed either directly or may be caused to be performed by the AI/ML model 308.

Returning to the present example, the UE 306-1 may need to collect certain data for the tasks. Each of the tasks involving the AI/ML model 308 may require different types of data possibly obtainable from different kind of measurements. As would be understood, the UE 306-1 may communicate with other network entities in the network using its respective radio communication link. Depending on the type of data that is to be collected, the radio communication link between the UE 306-1 and the network apparatus 302 may be configured.

It may be noted that the approaches of the present subject matter may be implemented for reconfiguring of any type of radio communication link associated with the UE 306-1, where the UE 306-1 may be operating in the network in any manner. For example, the radio communication link of the UE 306-1 may be configured so that the UE 306-1 may perform Radio Resource Management (RRM) L3 measurements. For another example, the same may be done so that the UE 306-1 may perform L1 measurements. All such and other examples would lie within the scope of the present subject matter.

It may be further noted that the approaches of the present subject matter may be implemented and applicable to both one-sided AI/ML model, as well as two-sided AI/ML model. As would be understood, the one-sided AI/ML model may be trained at one of the UE or the network apparatus. On the other hand, the two-sided AI/ML model may be trained at both the UE and the network apparatus. Both the models would be covered within the scope of the present subject matter.

In operation, as per an example of the present subject matter, the UE 306-1 may transmit a data collection request 416 to the network apparatus 302 (represented by step 502 in call flow diagram 500). The data collection request 416 may include an identifier 424 of a task (referred to as task identifier 424), which may involve and may be performed using the AI/ML model 308, for which the data is to be collected. As would be noted and understood, the AI/ML model 308 may be implemented within the UE 306-1 itself. For instance, the task identifier 424 may uniquely identify any one of the tasks from amongst training of the AI/ML model 308, retraining of the AI/ML model 308, monitoring of the AI/ML model 308, monitoring of functions performed by the UE 306-1, or inferencing using the AI/ML model 308. Although explained by way of the task identifier 424, similar such identifiers may be indicated in the data collection request 416 thereby indicating that the data collection is sought for more than one tasks.

In addition to the identifier 424, the data collection request 416 may further include additional information. For example, the data collection request may include a first set of attributes (referred to as first attributes 426), a type of request (referred to as request type 428), or other information. The first attributes 426 may define conditions based on which data collection corresponding to the data collection request 416 is to be performed. Examples of such first attributes 426 may include, but are not limited to, a time instance of initiating data collection, a time instance of terminating data collection, periodicity of data collection, sensitivity of data requirement, or a characteristic of a geographical area for performing the data collection. It may be noted that such first attributes 426 are only exemplary and are not to be construed to limit the scope of the present subject matter in any manner. Any other type of attributes defining the conditions based on which data collection is to be performed may also be used and would lie within the scope of the present subject matter.

Further, the request type 428 may indicate whether the request is for initiation or termination of the data collection. For example, the foregoing description has been explained with respect to the data collection request 416 being a data collection initiation request. As would be explained in the foregoing description, the network apparatus 302, upon receiving the data collection initiation request, may process the same and may reconfigure the radio communication link associated with the UE 306-1 for data collection.

On receiving the data collection request 416, the configuration engine 304 of the network apparatus 302 may process it and accordingly determine measurement configuration 418 corresponding to the task identifier 424 (represented by step 504 in call flow diagram 500). In one example, the configuration engine 304 may determine the measurement configuration 418 based on a predefined mapping that may be available with the network apparatus 302. The configuration engine 304, to this end, may retrieve a mapping between a plurality of tasks and a plurality of measurement configurations. In an example, the predefined mapping may be stored in other data 422. Based on the mapping and the task identifier 424 obtained from the data collection request 416, the configuration engine 304 may determine the measurement configuration 418. It may be noted that the measurement configuration 418 may be considered as defining manner in which the UE may perform measurements, any communication or data exchange, based on which the data collection process is to be performed by the UE 306-1. The measurement configuration 418 may indicate the characteristics of the communication link associated with the UE 306-1. The measurement configuration 418 may indicate either single characteristic or a plurality of characteristics based on which the radio communication link of the UE may be configured.

An exemplary table has been provided below, which illustrates various measurement configurations 418 and corresponding characteristics based on which the communication link associated with the UE 306-1 may be configured. It may be noted that the characteristics provided in the table below are only exemplary, and other examples would also lie within the scope of the present subject matter.

| Measurement Configuration | Measurement Quantity | Periodicity |
|---|---|---|
| Configuration 1 | RSRP/RSRQ/SINR | X ms |
| Configuration 2 | RSRP/RSRQ/SINR | Y ms |
| Configuration 3 | RSRP/RSRQ/SINR | Z ms |

In another example, the configuration engine 304 may use various different configuration settings for configuring the radio communication link associated with the UE 306-1 for the data collection. In such cases, the specific configuration settings may be used as measurement configuration 418 for reconfiguring the radio communication link associated with the UE 306-1. For instance, the configuration engine 304 may determine a first configuration based on which the configuration of the radio communication link may be performed. The first configuration may correspond to an earlier or current configured radio communication link associated with the UE 306-1. The configuration engine 304 may assess the first configuration based on the determined measurement configuration 418 to determine whether the first configuration can be used for configuring the radio communication link associated with the UE 306-1. In one example, on ascertaining that the first configuration can be used, the configuration engine 304 may use the first configuration as the measurement configuration(s) 418 for configuring the radio communication link associated with the UE 306-1 for the data collection. As would be appreciated, reusing configuration corresponding to an earlier or current configured radio communication link may reduce signal overheads.

However, upon assessing the first configuration, if the configuration engine 304 determines that the first configuration cannot be used for configuring the radio communication link associated with the UE 306-1 for the data collection, the configuration engine 304 may determine a second configuration, different from the first configuration. Thereafter, the configuration engine 304 may use the second configuration as the measurement configuration(s) 418 for configuring the radio communication link associated with the UE 306-1 for the data collection. Once the measurement configuration 418 is determined, the configuration engine 304 may generate a response message 420 based on the identified measurement configuration 418. In an example, the response message 420 may include an identifier of the identified measurement configuration 418 (referred to as measurement configuration identifier 430 or identifier 430). In another example, the response message 420 may also include the second configuration along with the corresponding identifier 430. Such inclusion of the measurement configuration 418 within the response message 420 may be useful when the UE 306-1 may be unaware of the configuration which may need to be performed based on the measurement configuration identifier 430.

In another example, the response message 420 may further include a list of a second set of attributes (referred to as second attributes 432). The second attributes 432 may correspond to the set of attributes, determined using the first attributes 426 or other criteria configured in Radio Access Network (RAN), based on which the data collection may be permissible and may be performed, once the radio communication link associated with the UE 306-1 has been configured. In one example, the second attributes 432 may be determined using the first attributes 426. For example, the first attributes 426 may require or suggest several time windows for the UE 306-1 to perform the data collection. The second attribute(s) 432 may comprise one of those time windows, so that the UE 306-1 can perform the data collection during the time window of the second attribute(s) 432.

In another example, it may be the case that the values which may be provided in the first attributes 426 may not be suitable for data collection. In such cases, the second set of attributes 432 may be determined using other criteria configured in Radio Access Network (RAN). The configuration engine 304 may provide additional attributes as second set of attributes 432 based on which the data collection may be done once the radio communication link associated with the UE 306-1 is configured. For example, the first attributes 426 may provide characteristic of geographical area where the UE 306-1 may be operating and the data collection is to be performed. If the geographical area as provided in the first attributes 426 is not suitable for data collection, the configuration engine 304 may suggest a new area where the data collection is to be enabled by the UE 306-1 in the second set of attributes 432. In another example, the second attributes 432 may also include an indication that data collection could not be implemented using the first set of attributes 426, and an additional attribute as second set of attributes 432 has been provided.

In yet another example, the response message 420 may further include a reporting notification, which when received by the UE, may notify the UE 306-1 to report additional information to the network apparatus 302. Examples of such additional information may include, but are not limited to, number of data collection sessions, corresponding data collection time stamps, and number of data samples collected. It may be noted that such list of examples is not exhaustive, and any other examples would also be covered within the scope of the present subject matter. Thereafter, the response message 420 may be transmitted to the UE 306-1 within the access network (represented by step 506 in call flow diagram 500). The UE 306-1 may receive the response message 420. Upon receiving the response message 420, the radio communications link associated with the UE 306-1 may be configured (represented by step 508 in call flow diagram 500). In one example, the configuration of the radio communication link may be done by way of a RRC Reconfiguration.

In another example, upon receiving the response message 420, the UE 306-1 may transmit an acknowledgement message to the network apparatus 302 (represented by step 510 in call flow diagram 500). Such acknowledgement message may indicate successful or unsuccessful reception of the measurement configuration 418 in the received response message 420.

As would be noted, the radio communication link associated with the UE 306-1 may be configured based on the measurement configuration corresponding to the measurement configuration identifier 430 received in the response message 420.

Once the radio communication link is configured, the collection engine 310 may then collect data based on the configuration by the network apparatus 302 (represented by step 512 in call flow diagram 500). As described previously, the data is to be collected for a task involving the AI/ML model 308. Examples of such tasks include, but are not limited to, training of the AI/ML model 308, retraining of the AI/ML model 308, monitoring of the AI/ML model 308, monitoring of functions performed by the UE 306-1, inferencing using the AI/ML model 308, or combination thereof. Such tasks involving the AI/ML model 308 would be well understood by a person skilled in the art, and the explanation of the same has not been provided here for the sake of brevity. It may be again noted that data may be collected for any other tasks as well. All such additional examples would lie within the scope of the present subject matter.

It may be noted that, as described previously, different types of configuration settings may be used for configuration of the radio communication link associated with the UE 306-1. Some exemplary use cases have been described herein in detail.

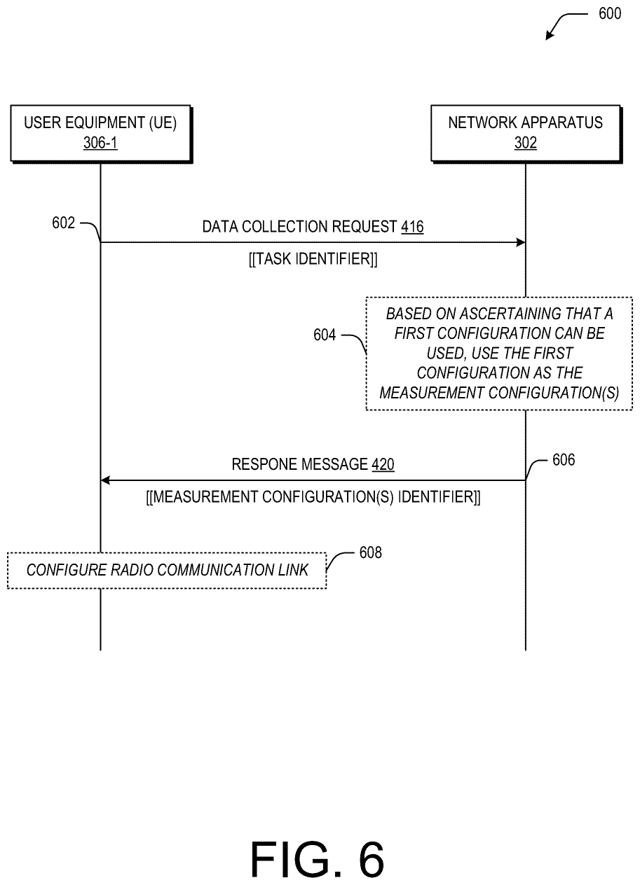

In a first example, the radio communication link associated with the UE 306-1 may be configured based on configuration settings which are similar to characteristics of an earlier configured radio communication link that may have been previously established by the UE 306-1. Such an example has been described in conjunction with call flow diagram 600. FIG. 6 illustrates an example call-flow diagram 600 depicting an example in which the radio communication link associated with the UE 306-1 may be configured based on a similar configuration settings of an earlier configured radio communication link associated with the UE 306-1. As described previously, such configuration settings have been referred to as first configuration.

In such cases, the UE 306-1 may transmit the data collection request 416 to the network apparatus 302 (represented by step 602 in call flow diagram 600). The data collection request 416 may include identifier 424 of a task which may involve the AI/ML model 308, for which the data is to be collected. The explanation has been provided previously, and the same is not described here again for the sake of brevity.

On receiving the data collection request 416, the configuration engine 304 of the network apparatus 302 may process the same. The configuration engine 304 may determine a first configuration based on which the configuration of the radio communication link may be performed. The first configuration may correspond to characteristics of an earlier configured radio communication link associated with the UE 306-1. The configuration engine 304 may assess the first configuration based on the determined measurement configuration 418 to determine whether the first configuration can be used for configuring the radio communication link associated with the UE 306-1 for the data collection. Upon ascertaining that the first configuration can be used, the configuration engine 304 may use the first configuration as the measurement configuration 418 for configuring the radio communication link associated with the UE 306-1 for the data collection (represented by step 604 in call flow diagram 600). As would be appreciated, reusing configuration corresponding to an earlier configured radio communication link may reduce signal overheads.

Once the measurement configuration 418 is determined, the configuration engine 304 may generate and transmit a response message 420, based on the identified measurement configuration 418, to the UE 306-1 (represented by step 606 in call flow diagram 600). In an example, the response message 420 may include an identifier of the identified measurement configuration 418 (referred to as measurement configuration identifiers 430 or identifiers 430).

The UE 306-1 may receive the response message 420. Upon receiving the response message 420, the radio communication link associated with the UE 306-1 may be configured (represented by step 608 in call flow diagram 600). As would be noted, the radio communication link associated with the UE 306-1 may be configured based on the first configuration.

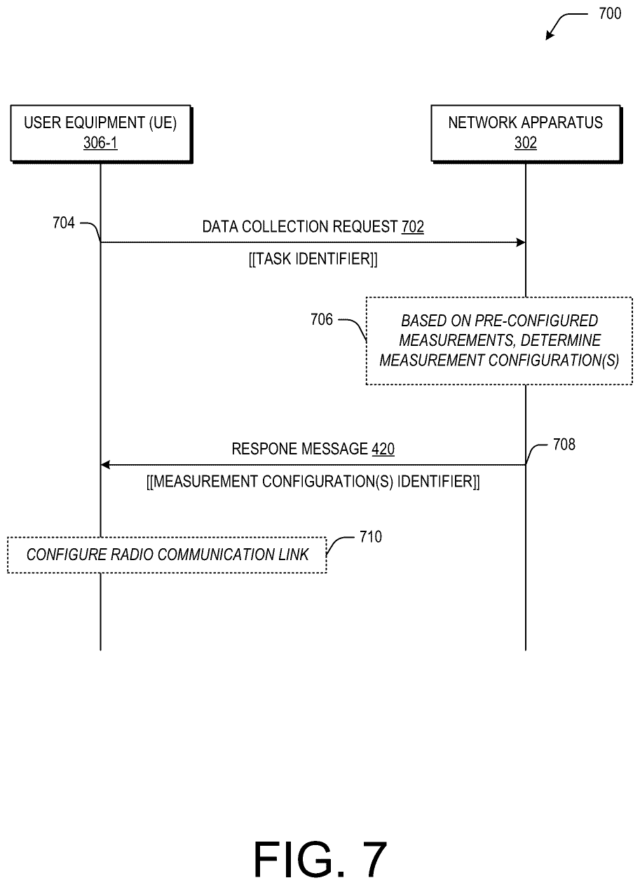

In another example, the radio communication link may be previously configured. In such cases, the radio communication link associated with the UE 306-1 may need to be configured on top of the previous configuration associated with the UE 306-1. FIG. 7 illustrates an example call-flow diagram 700 depicting an example in which the radio communication link associated with the UE 306-1 may be previously configured, and may seek additional configuration.

In relation to FIG. 7, the UE 306-1 may transmit a data collection request 702 to the network apparatus 302 (represented by step 704 in call flow diagram 700). In an example, the data collection request 702 may include identifier 424 of the task for which data is to be collected.

On receiving the data collection request 702, the configuration engine 304 of the network apparatus 302 may process the same. Based on the received data collection request 702 and the task identifiers 424, the configuration engine 304 may determine measurement configuration 418 (represented by step 706 in call flow diagram 700). As would be appreciated, such measurement configuration 418 may be determined based on the additional measurements which may be required by the UE 306-1 on top of the previously configured measurements. In an example, the measurement configuration 418 may include configurations that may be completely different to affect the data collection by the UE 306-1.

Once the measurement configuration 418 is determined, the configuration engine 304 may generate and transmit a response message 420, based on the identified measurement configuration 418, to the UE 306-1 (represented by step 708 in call flow diagram 700). In an example, the response message 420 may include an identifier of the identified measurement configuration 418 (referred to as measurement configuration identifiers 430 or identifiers 430). In another example, the response message 420 may also include the measurement configuration 418 together with the corresponding identifier 430.

The UE 306-1 may receive the response message 420. Upon receiving the response message 420, the radio communications link associated with the UE 306-1 may be configured (represented by step 710 in call flow diagram 700). As would be noted, the radio communication link associated with the UE 306-1 may therefore be additionally configured on top of previously configured radio communication link.

It may be noted that the aforementioned use cases and corresponding call flow diagrams are only exemplary, and should not be construed to limit the scope of the present subject matter in any manner. The radio communication link associated with the UE 306-1 may be configured based on any combination of the above described manner, or based on measurement configuration corresponding to the measurement configuration identifiers 430 received in the response message 420. For example, it may be the case that the radio communication link associated with the UE 306-1 may be partially configured based on settings similar to the earlier configured radio communication link, and partially based on additional measurements provided by the network apparatus 302. All such examples would lie within the scope of the present subject matter.

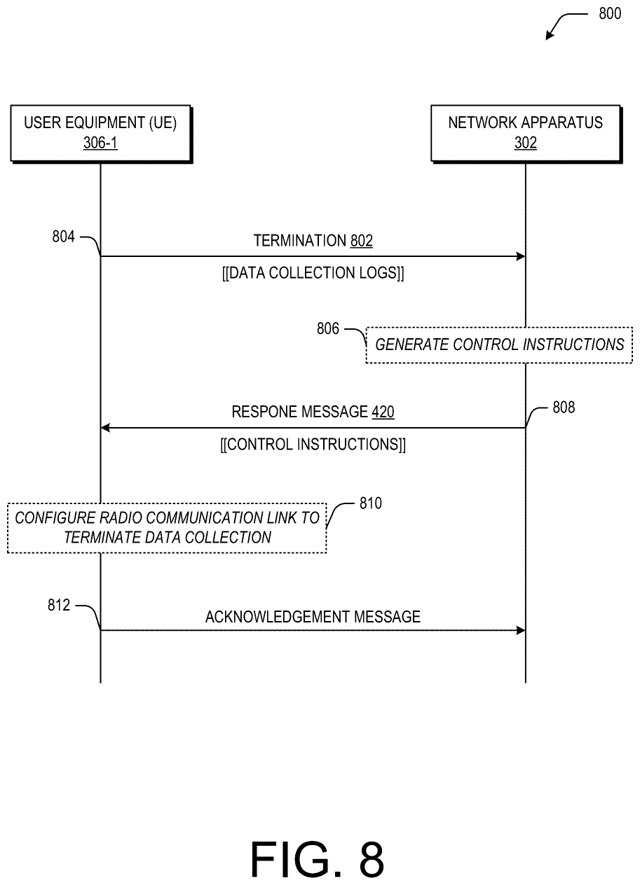

Once the radio communication link has been configured for data collection, the same may be terminated by the UE 306-1. FIG. 8 illustrates an example call-flow diagram 800 depicting an example in which the data collection may be terminated by the UE 306-1.

For terminating the data collection procedure, the UE 306-1 may transmit a termination request 802 to the network apparatus 302 (represented by step 804 in call flow diagram 800), in which the UE 306-1 may indicate that the data collection is to be terminated. The termination request 802, in one example, may include logs pertaining to the data collection performed pursuant to the data collection request (as explained above).

The network apparatus 302 may receive the termination request 802. Based on the received termination request 802, the configuration engine 304 may then generate control instructions (represented by step 806 in call flow diagram 800). In one example, the configuration engine 304 may generate the control instructions based on a determination that the termination request 802 conforms with a predefined condition. The control instructions may then be transmitted to the UE 306-1 in the form of the response message 420 (represented by step 808 in call flow diagram 800). The UE 306-1, on receiving the response message 420, may execute the control instructions. The control instructions, upon execution, may further reconfigure the radio communication link associated with the UE 306-1 to terminate the data collection by the UE 306-1 (represented by step 810 in call flow diagram 800). In another example, upon reconfiguration of the radio communication link to terminate the data collection, the UE 306-1 may transmit an acknowledgement message to the network apparatus 302 (represented by step 812 in call flow diagram 800). Such acknowledgement message may notify the network apparatus 302 that data collection termination process has been completed.

Although not depicted, the termination of the data collection may be initiated by the network apparatus 302 as well, without receiving any such termination request 802 from the UE 306-1. For example, based on one or more predefined conditions, the network apparatus 302 may generate control instructions for reconfiguring the radio communication link to terminate the data collection. Such an example would also fall within the purview of the claimed subject matter.

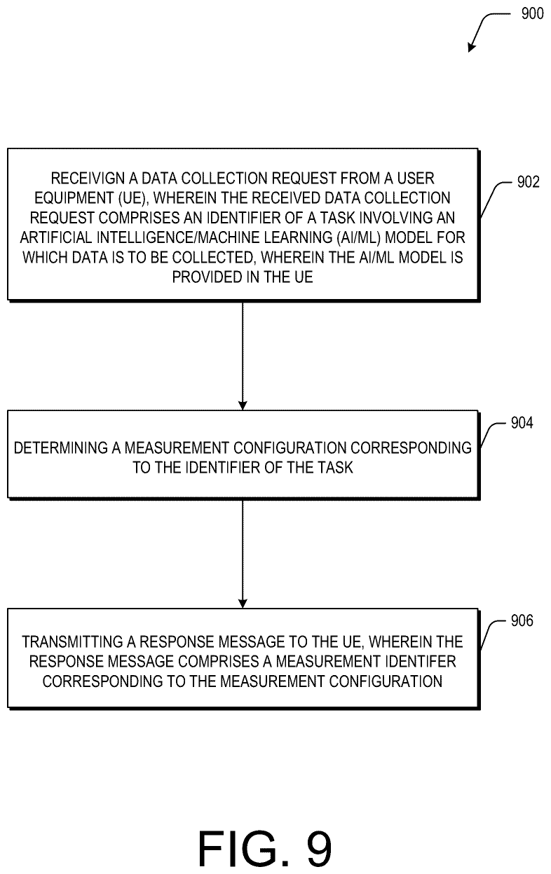

FIG. 9 illustrate example method 900, to be implemented in a network apparatus, for implementing data collection for a task involving an Artificial Intelligence/Machine Learning (AI/ML) model present with the UE, as per an implementation of the present subject matter. The order in which the method is described is not intended to be construed as a limitation, and any number of the described method blocks may be combined in any order to implement the aforementioned method, or an alternative method. Furthermore, method 900 may be implemented by processing resource or computing device(s) through any suitable hardware, non-transitory machine-readable program instructions, or combination thereof, or through logical circuitry.

It may also be understood that method 900 may be performed by programmed and/or configured network devices present within a network, with such devices including the network apparatus 302 as depicted in FIGS. 3-8. Furthermore, in certain circumstances, program instructions stored in a non-transitory computer readable medium when executed may implement method 900 as will be readily understood. The non-transitory computer readable medium may include, for example, digital memories, magnetic storage media, such as one or more magnetic disks and magnetic tapes, hard drives, or optically readable digital data storage media. Although, the method 900 is described below with reference to the network apparatus 302, as described above, other suitable systems for the execution of this method can be utilized. Additionally, implementation of this method is not limited to such examples.

At block 902, the network apparatus may receive a data collection request from a User Equipment (UE). The data collection request may include an identifier of a task involving an Artificial Intelligence/Machine Learning (AI/ML) model for which data is to be collected. The AI/ML model may be provided in the UE. For example, a plurality of User Equipment (UEs) 306 may be in communication with a network apparatus 302 in the access network. Each of the UEs 306 may include an Artificial Intelligence/Machine Learning (AI/ML) model 308. For utilizing the AI/ML model 308 for implementing a variety of UE related functions by a UE, say UE 306-1, various tasks may need to be performed, such as training of the AI/ML model 308, retraining of the AI/ML model 308, monitoring of the AI/ML model 308, monitoring of functions performed by the UE 306-1, inferencing using the AI/ML model 308, etc. Each of the tasks involving the AI/ML model 308 may require different types of data. Therefore, the UE 306-1 may need to collect certain data. To this extent, in operation, the UE 306-1 may transmit a data collection request 416, which may be received by the network apparatus 302. The data collection request 416 may include an identifier 424 of a task (referred to as task identifier 424), which may involve and may be performed using the AI/ML model 308, for which the data is to be collected.

At block 904, the network apparatus may determine a measurement configuration corresponding to the identifier of the task. For example, on receiving the data collection request 416, the configuration engine 304 of the network apparatus 302 may process it and accordingly determine measurement configuration 418 corresponding to the task identifier 424. It may be noted that the measurement configuration 418 may be considered as defining manner in which the UE may perform any communication or data exchange, based on which the data collection process is to be performed by the UE 306-1.

At block 906, the network apparatus may transmit a response message to the UE. The response message may include a measurement identifier corresponding to the measurement configuration. For example, once the measurement configuration 418 is determined, the configuration engine 304 may generate a response message 420 based on the identified measurement configuration 418. In an example, the response message 420 may include an identifier of the identified measurement configuration 418 (referred to as measurement configuration identifiers 430 or identifiers 430). The response message 420 may be transmitted to the UE 306-1 within the access network.

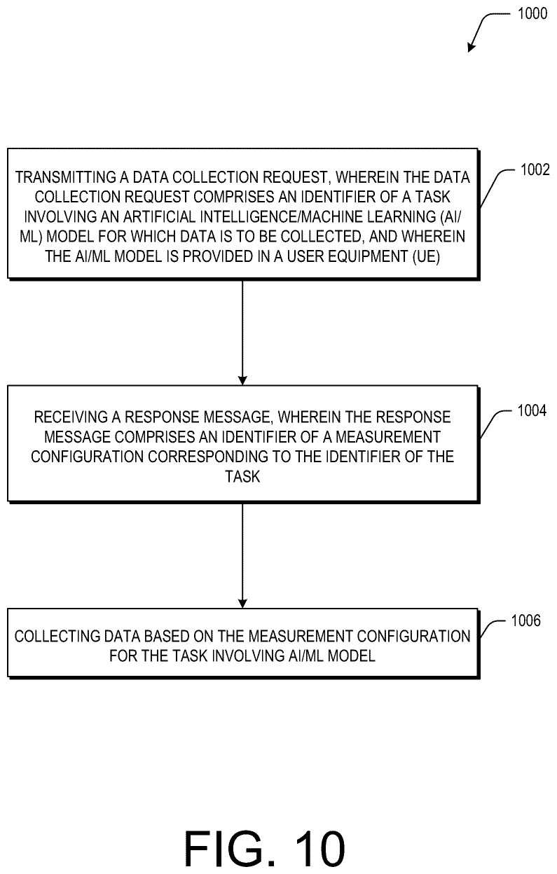

FIG. 10 illustrate example method 1000, to be implemented in a User Equipment (UE), for implementing data collection for a task involving an Artificial Intelligence/Machine Learning (AI/ML) model present with the UE, as per an implementation of the present subject matter. The method 1000 may be performed by programmed and/or configured network devices present within a network, with such devices including the User Equipment 306-1 as depicted in FIGS. 3 and 5-8.

At block 1002, the User Equipment (UE) may transmit a data collection request. The data collection request may include an identifier of a task involving an Artificial Intelligence/Machine Learning (AI/ML) model for which data is to be collected. The AI/ML model may be provided in the UE. For example, a plurality of User Equipment (UEs) 306 may be in communication with a network apparatus 302 in the access network. Each of the UEs 306 may include an Artificial Intelligence/Machine Learning (AI/ML) model 308. For utilizing the AI/ML model 308 for implementing a variety of UE related functions by a UE, say UE 306-1, various tasks may need to be performed, such as training of the AI/ML model 308, retraining of the AI/ML model 308, monitoring of the AI/ML model 308, monitoring of functions performed by the UE 306-1, inferencing using the AI/ML model 308, etc. Each of the tasks involving the AI/ML model 308 may require different types of data. Therefore, the UE 306-1 may need to collect certain data. To this extent, in operation, the UE 306-1 may transmit a data collection request 416 to the network apparatus 302. The data collection request 416 may include an identifier 424 of a task (referred to as task identifier 424), which may involve and may be performed using the AI/ML model 308, for which the data is to be collected.

At block 1004, the UE may receive a response message. The response message may include an identifier of a measurement configuration corresponding to the identifier of the task. For example, on receiving the data collection request 416, the configuration engine 304 of the network apparatus 302 may process it and accordingly determine measurement configuration 418 corresponding to the task identifier 424. It may be noted that the measurement configuration 418 may be considered as defining manner in which the UE may perform any communication or data exchange, based on which the data collection process is to be performed by the UE 306-1. The response message 420 may be transmitted to the UE 306-1 within the access network.

At block 1006, the UE may collect data based on the measurement configuration for the task involving the AI/ML model. For example, the UE 306-1 may receive the response message 420. Upon receiving the response message 420, the radio communications link associated with the UE 306-1 may be configured. The radio communication link associated with the UE 306-1 may be configured based on the measurement configuration corresponding to the measurement configuration identifiers 430 received in the response message 420. Once the radio communication link is configured, the collection engine 310 may then collect data based on the configuration by the network apparatus 302.

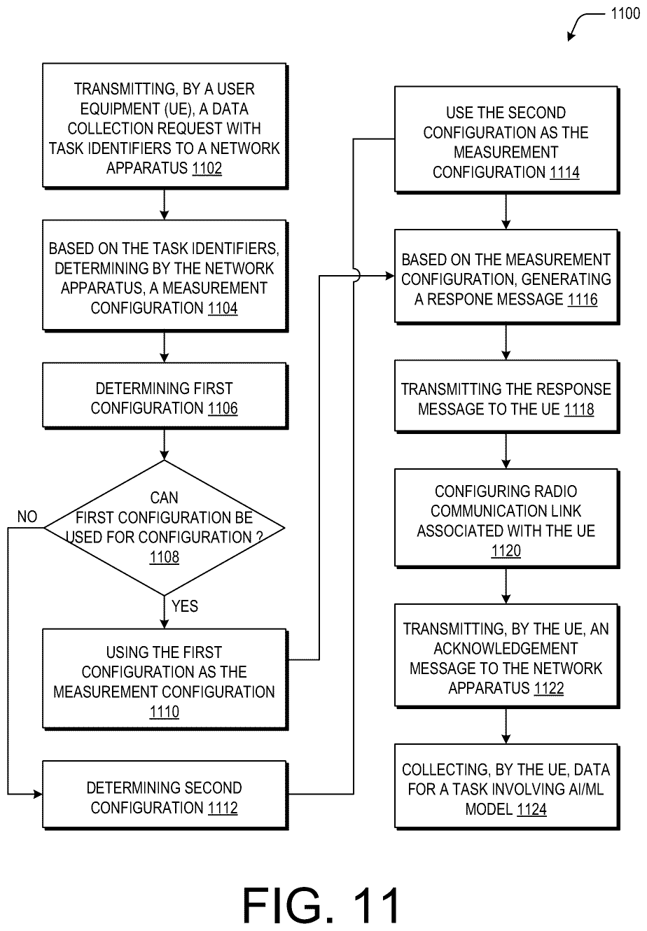

FIG. 11 depicts an example method 1100 for implementing data collection for a task involving an Artificial Intelligence/Machine Learning (AI/ML) model present with a User Equipment (UE), as per an implementation of the present subject matter.

At block 1102, the User Equipment (UE) may transmit a data collection request with task identifiers to a network apparatus. For example, a plurality of User Equipment (UEs) 306 may be in communication with a network apparatus 302 in the access network. Each of the UEs 306 may include an Artificial Intelligence/Machine Learning (AI/ML) model 308. For utilizing the AI/ML model 308 for implementing a variety of UE related functions by a UE 306, say UE 306-1, various tasks may need to be performed, such as training of the AI/ML model 308, retraining of the AI/ML model 308, monitoring of the AI/ML model 308, monitoring of functions performed by the UE 306-1, inferencing using the AI/ML model 308, etc. Each of the tasks involving the AI/ML model 308 may require different types of data. Therefore, the UE 306-1 may need to collect certain data. To this extent, in operation, the UE 306-1 may transmit a data collection request 416 to the network apparatus 302. The data collection request 416 may include an identifier 424 of a task (referred to as task identifier 424), which may involve and may be performed using the AI/ML model 308, for which the data is to be collected. In addition to the identifier 424, the data collection request 416 may further include additional information. For example, the data collection request may include a first set of attributes (referred to as first attributes 426), a type of request (referred to as request type 428), or other information.

At block 1104, based on the task identifiers, the network apparatus may determine a measurement configuration. For example, the network apparatus 302 may receive the data collection request 416 from the UE 306-1. On receiving the data collection request 416, the configuration engine 304 of the network apparatus 302 may process it and accordingly determine measurement configuration 418 corresponding to the task identifier 424.

At block 1106, first configuration may be determined. For example, the radio communication link associated with the UE 306-1 may be configured using different configuration settings. The configuration engine 304 may determine first configuration. The first configuration may correspond to an earlier configured radio communication link associated with the UE 306-1.

At block 1108, a determination may be made to ascertain whether first configuration can be used for configuration or not. For example, based on the determined measurement configurations 418, the configuration engine 304 may assess the first configuration to determine whether the first configuration can be used for configuring the radio communication link associated with the UE 306-1 for the data collection or not. Upon assessing, if the configuration engine 304 determines that the first configuration can be used for configuring the radio communication link associated with the UE 306-1 for the data collection (‘Yes’ path from block 1108), the configuration engine 304 may use the first configuration as the measurement configuration 418 (block 1110).

However, upon assessing of the first configuration, if the configuration engine 304 determines that the first configuration cannot be used for configuring the radio communication link associated with the UE 306-1 for the data collection (‘No’ path from block 1108), the configuration engine 304 may determine second configuration (block 1112). Thereafter, the configuration engine 304 may use the second configuration as the measurement configuration 418 (block 1114).

In another example, it may be the case that the radio communication link associated with the UE 306-1 may be previously configured. In such cases, the configuration engine 304, while determining the measurement configuration 418, may also take into consideration the measurements of the previously configured radio communication link associated with the UE 306-1.

At block 1116, based on the measurement configuration, a response message may be generated. For example, once the measurement configuration 418 is determined, the configuration engine 304 may generate a response message 420 based on the identified measurement configuration 418. In an example, the response message 420 may include an identifier of the identified measurement configuration 418 (referred to as measurement configuration identifiers 430 or identifiers 430).

At block 1118, the response message may be transmitted to the User Equipment (UE). For example, thereafter the response message 420 may be transmitted to the UE 306-1 within the access network.

At block 1120, radio communication link associated with the UE may be configured. For example, the UE 306-1 may then receive the response message 420. Upon receiving the response message 420, the radio communications link associated with the UE 306-1 may be configured. In one example, the configuration of the radio communication link may be done by way of a RRC Reconfiguration.

At block 1122, the User Equipment (UE) may transmit an acknowledgement message to the network apparatus. For example, upon receiving the response message 420, the UE 306-1 may transmit an acknowledgement message to the network apparatus 302. Such acknowledgement message may indicate successful or unsuccessful reception of the measurement configuration in the received response message 420.

At block 1124, the User Equipment (UE) may collect data for a task involving Artificial Intelligence/Machine Learning (AI/ML) model. For example, once the radio communication link is configured, the collection engine 310 may then collect data based on the configuration by the network apparatus 302. The data is to be collected for a task involving the AI/ML model 308. Examples of such tasks include, but are not limited to, training of the AI/ML model 308, retraining of the AI/ML model 308, monitoring of the AI/ML model 308, monitoring of functions performed by the UE 306-1, inferencing using the AI/ML model 308, or combination thereof.

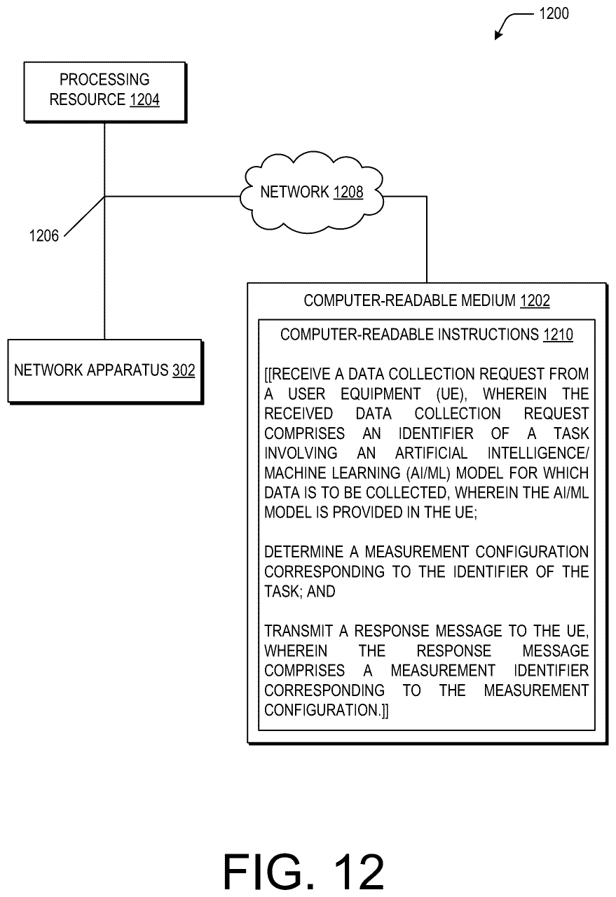

FIG. 12 illustrates a computing environment 1200 implementing a non-transitory computer-readable medium 1202 for implementing data collection for a task involving an Artificial Intelligence/Machine Learning (AI/ML) model present with a User Equipment (UE), as per an implementation of the present subject matter. In an example, the computing environment 1200 may comprise the above-explained network apparatus 302. The computing environment 1200 includes a processing resource 1204 communicatively coupled to the non-transitory computer-readable medium 1202 through a communication link 1206. In an example, the processing resource 1204 may be a processor or a controller within the network apparatus 302 that fetches and executes computer-readable instructions from the non-transitory computer-readable medium 1202.

The non-transitory computer-readable medium 1202 may be, for example, an internal memory device or an external memory device. In an example, the communication link 1206 may be a direct communication link, such as any memory read/write interface. In another example, the communication link 1206 may be an indirect communication link, such as a network interface. In such a case, the processing resource 1204 may access the non-transitory computer-readable medium 1202 through a network 1208. The network 1208 may be a single network or a combination of multiple networks and may use a variety of different communication protocols.

In an example, the non-transitory computer-readable medium 1202 comprises executable instructions 1210 for servicing the network apparatus 302. For example, the non-transitory computer-readable medium 1202 may comprise executable instructions 1210 to implement the functions performed by the network apparatus 302. The instructions 1210 when executed may cause the network apparatus 302 to receive a data collection request 416 from a User Equipment (UE) 306-1. The received data collection request 416 may include an identifier of a task (referred to as task identifier 424) involving an Artificial Intelligence/Machine Learning (AI/ML) model 308, provided in the UE 306-1, for which data is to be collected. Examples of such tasks involving the AI/ML model 308 may include, but are not limited to, training of the AI/ML model 308, retraining of the AI/ML model 308, monitoring of the AI/ML model 308, monitoring of functions performed by the UE 306-1, or inferencing using the AI/ML model 308. It may be noted that the following examples are only indicative and are not exhaustive. Other example tasks may also be possible without deviating from the scope of the present subject matter.

Thereafter, the instructions 1210 may be further executed to determine a measurement configuration 418 corresponding to the task identifier 424. For example, the measurement configuration 418 indicate the manner in which the UE 306-1 may perform any communication or implement exchange of data.

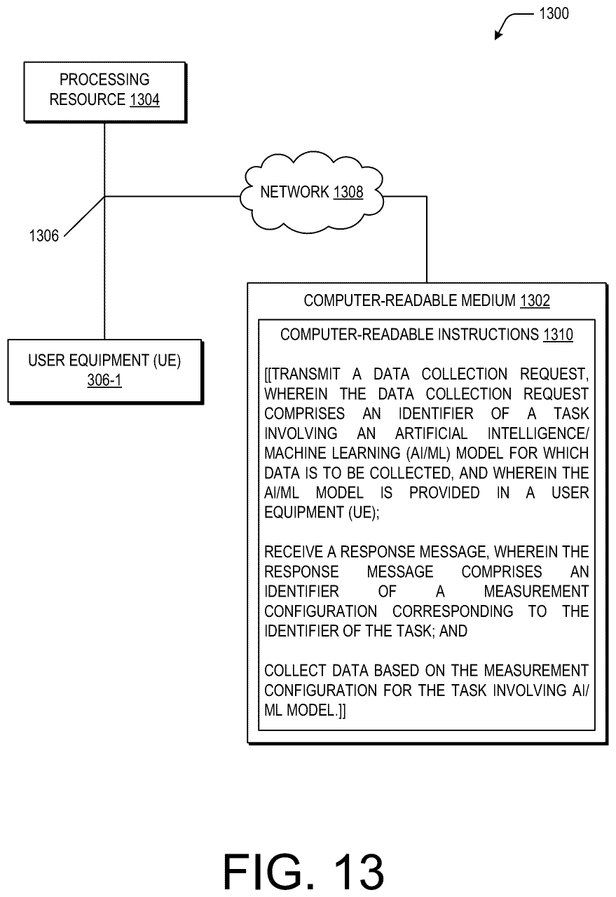

Thereafter, the instructions 1210 may be executed to transmit a response message 420 to the UE 306-1. The response message 420 may include an identifier of the measurement configuration (referred to as measurement configuration identifier 430). The response message 420, once received by the UE 306-1, may cause to reconfigure the radio communication link associated with the UE 306-1. FIG. 13 illustrates a computing environment 1300 implementing a non-transitory computer-readable medium 1302 for implementing data collection for a task involving an Artificial Intelligence/Machine Learning (AI/ML) model present with a User Equipment (UE), as per another implementation of the present subject matter. In an example, the computing environment 1300 may comprise the above-explained User Equipment 306-1. The computing environment 1300 includes a processing resource 1304 communicatively coupled to the non-transitory computer-readable medium 1302 through a communication link 1306. In an example, the processing resource 1304 may be a processor or a controller within the User Equipment (UE) 306-1 that fetches and executes computer-readable instructions from the non-transitory computer-readable medium 1302.

In another example, the non-transitory computer-readable medium 1302, communication link 1306, and network 1308 may be implemented in a similar manner as that of non-transitory computer-readable medium 1202, communication link 1206, and network 1208 respectively.

In an example, the non-transitory computer-readable medium 1302 comprises executable instructions 1310 for servicing the User Equipment (UE) 306-1. For example, the non-transitory computer-readable medium 1302 may comprise executable instructions 1310 to implement the functions performed by the UE 306-1. The instructions 1310 when executed may cause the UE 306-1 to transmit a data collection request 416. The data collection request 416 may include an identifier of a task (referred to as task identifier 424) involving an Artificial Intelligence/Machine Learning (AI/ML) model 308, provided in the UE 306-1, for which data is to be collected. Examples of such tasks involving the AI/ML model 308 may include, but are not limited to, training of the AI/ML model 308, retraining of the AI/ML model 308, monitoring of the AI/ML model 308, monitoring of functions performed by the UE 306-1, or inferencing using the AI/ML model 308. It may be noted that the following examples are only indicative and are not exhaustive. Other example tasks may also be possible without deviating from the scope of the present subject matter.

Thereafter, the instructions 1310 may be further executed to receive a response message 420. The response message 420 may include an identifier of the measurement configuration (referred to as measurement configuration identifier 430).

Thereafter, the instructions 1310 may be executed to collect data based on the measurement configuration for the task involving the AI/ML model 308.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A network apparatus comprising:
at least one processor; and
at least one memory storing instructions that, when executed by the at least one processor, cause the network apparatus at least to:
receive a data collection request from a user equipment (UE), wherein the received data collection request comprises an identifier of a task involving an artificial intelligence/machine learning (AI/ML) model for which data is to be collected, wherein the AI/ML model is provided in the UE;
determine a measurement configuration corresponding to the identifier of the task; and
transmit a response message to the UE, wherein the response message comprises a measurement identifier corresponding to the measurement configuration.

2. The network apparatus as claimed in claim 1, wherein the instructions, when executed by the at least one processor, cause the network apparatus further to reconfigure a radio communication link associated with the UE, based on the measurement configuration corresponding to the measurement identifier.

3. The network apparatus as claimed in claim 1, wherein the data collection request further comprises at least one of:
a first set of attributes for the data collection corresponding to the data collection request; or
a type of request, wherein the type indicates one of initiation or termination of the data collection.

4. The network apparatus as claimed in claim 3, wherein the first set of attributes comprises at least one of a time instance of initiating data collection, a time instance of terminating data collection, periodicity of data collection, sensitivity of data requirement, or a characteristic of a geographical area for performing the data collection.

5. The network apparatus as claimed in claim 3, wherein the response message further comprises a list of a second set of attributes, wherein the second set of attributes is determined using the first set of attributes.

6. The network apparatus as claimed in claim 1, wherein the instructions, when executed by the at least one processor, cause the network apparatus further to:
retrieve a mapping between a plurality of tasks and a plurality of measurement configurations; and
based on the mapping and the identifier of the task obtained from the data collection request, determine the measurement configuration.

7. The network apparatus as claimed in claim 1, wherein the instructions, when executed by the at least one processor, cause the network apparatus further to:
determine a first configuration corresponding to an earlier configured radio communication link associated with the UE;
assess the first configuration based on the determined measurement configuration to determine whether the first configuration can be used for configuring the radio communication link associated with the UE for the data collection; and
on ascertaining that the first configuration can be used for configuring the radio communication link associated with the UE for the data collection, use the first configuration as the measurement configuration.

8. The network apparatus as claimed in claim 7, wherein the instructions, when executed by the at least one processor, cause the network apparatus further to:
ascertaining, based on the assessing of the first configuration, that the first configuration cannot be used for configuring the radio communication link associated with the UE for the data collection;
determine a second configuration; and
use the second configuration as the measurement configuration for configuring the radio communication link associated with the UE for the data collection.

9. The network apparatus as claimed in claim 1, wherein the instructions, when executed by the at least one processor, cause the network apparatus further to:
process the data collection request received from the UE, wherein the radio communication link associated with the UE is configured previously;
based on a previously configured measurement of the UE, determine the measurement configuration; and
transmit the response message to the UE, wherein the response message comprises the measurement identifier corresponding to the measurement configuration to configure the previously configured radio communication link associated with the UE.

10. The network apparatus as claimed in claim 1, wherein the instructions, when executed by the at least one processor, cause the network apparatus further to:
process a data collection termination request received from the UE, wherein the termination request comprises logs pertaining to the data collection performed pursuant to the data collection request; and
transmit control instructions to the UE on determining that the termination request conforms with a predefined condition, wherein the control instructions are executable by the UE to reconfigure a radio communication link associated with the UE to terminate the data collection by the UE.

11. A user equipment (UE) comprising:
at least one processor; and
at least one memory storing instructions that, when executed by the at least one processor, cause the user equipment (UE) to:
transmit a data collection request, wherein the data collection request comprises an identifier of a task involving an artificial intelligence/machine learning (AI/ML) model for which data is to be collected, and wherein the AI/ML model is provided in the UE;
receive a response message by the UE, wherein the response message comprises a measurement identifier of a measurement configuration corresponding to the identifier of the task; and
collect data, based on the measurement configuration, for the task involving the AI/ML model.

12. The user equipment (UE) as claimed in claim 11, wherein the task comprises at least one of training of the AI/ML model, retraining of the AI/ML model, monitoring of the AI/ML model, monitoring of functions performed by the UE, or inferencing using the AI/ML model.

13. The user equipment (UE) as claimed in claim 11, wherein the data collection request further comprises at least one of:
a first set of attributes for the data collection corresponding to the data collection request; or
a type of request, wherein the type indicates one of initiation or termination of the data collection.

14. The user equipment (UE) as claimed in claim 13, wherein the first set of attributes comprises at least one of a time instance of initiating data collection, a time instance of terminating data collection, periodicity of data collection, sensitivity of data requirement, or a characteristic of a geographical area for performing the data collection.

15. The user equipment (UE) as claimed in claim 11, wherein the instructions, when executed by the at least one processor, cause the user equipment further to:
transmit a termination request, wherein the termination request comprises logs pertaining to the data collection performed pursuant to receiving the response message; and
execute control instructions received from a network apparatus in response to the termination request, wherein the control instructions when executed are to further reconfigure a radio communication link to terminate the data collection by the UE.

16. A method comprising:
transmitting, by a user equipment (UE), a data collection request, wherein the data collection request comprises an identifier of a task involving an artificial intelligence/machine learning (AI/ML) model for which data is to be collected, and wherein the AI/ML model is provided in the UE;
receiving, by the UE, a response message, wherein the response message comprises an identifier of a measurement configuration corresponding to the identifier of the task; and
collecting, by the UE, data, based on the measurement configuration, for the task involving the AI/ML model.

17. The method as claimed in claim 16, wherein the task comprises at least one of training of the AI/ML model, retraining of the AI/ML model, monitoring of the AI/ML model, monitoring of functions performed by the UE, or inferencing using the AI/ML model.

18. The method as claimed in claim 16, wherein the data collection request comprises one of:
a first set of attributes for the data collection corresponding to the data collection request; and
a type of request, wherein the type indicates one of initiation or termination of the data collection.

19. The method as claimed in claim 18, wherein the first set of attributes comprises at least one of a time instance of initiating data collection, a time instance of terminating data collection, periodicity of data collection, sensitivity of data requirement, or a characteristic of a geographical area for performing the data collection.

20. The method of claim 16, further comprising:
transmitting, by the UE, a termination request, wherein the termination request comprises logs pertaining to the data collection performed pursuant to receiving the response message; and
executing control instructions received from a network apparatus in response to the termination request, wherein the control instructions when executed are to further reconfigure a radio communication link to terminate the data collection by the UE.
